(19) United States
(12) Patent Application Publication
(10) Pub. No.: US 2009/0045226 A1
(43) Pub. Date: Feb. 19, 2009

(54) Fuel dispenser system

(76) Inventor: Cody Munlin, Baytown, TX (US)

Correspondence Address: WINSTEAD PC, P.O. BOX 50784, DALLAS, TX, 75201, US

(21) Appl. No.: 11/893,206

(22) Filed: Aug. 15, 2007

(51) Int. Cl. B67D 5/38; B67D 3/00; A47G 19/14

(52) U.S. Cl. 222/158; 222/478; 222/529; 222/465.1

(57) ABSTRACT

A fuel dispensing system including a internally hollow container for use in containing and dispensing a fuel, where the container comprises a lower fuel dispensing orifice, and a dispensing nozzle coupled to the internally hollow container at the lower fuel dispensing orifice capable of being positioned in at least an open or closed state, where the dispensing nozzle is coupled with the container at the lower fuel dispensing orifice in such a manner as to provide a fluid pathway between the internal portion of the container and the distal end of the dispensing nozzle when the dispensing nozzle is positioned in an open state.

### BACKGROUND

1. Field of Invention

This invention relates to fuel containers of the type used to transport and dispense fuel. More particularly, this invention is a new and improved portable fuel dispensing container system for conveniently and controllably dispensing fuel.

2. History of Related Art

The use of portable fuel dispensing container for servicing lawn mowers or other devices possessing a fuel tank remote from a fixed source of fuel is well known in the art. Such containers provide a convenient means for replenishing expended fuels in devices that require periodic refueling; sometimes at remote locations where fuel distributed from mass-flow devices is not available.

Dispensing fuel from a dispensing container into a fuel tank can often be an arduous and unsafe task performed under less-than-desirable conditions. This is especially true when volatile liquid fuels, such as gasoline, kerosene, or a gas/oil mix, are the source of fuel. Such a task traditionally involves the lifting or tilting of a potentially heavy (if filled) fuel can so that a user may induce pouring of the fuel from the container to the fuel tank of a device to be filled. Typically, a fuel container will possess a directional spout on top of the container and require the container to be tilted to facilitate fuel flow from the container into the fuel tank.

Control over the flow rate and the amount of fuel dispensed from the dispensing container can be difficult, especially when refueling involves a small fuel tank. For one, the container and spout are often opaque, so the user cannot see the amount of fuel being distributed to the tank or its flow rate. Second, the person using the dispensing container in such a manner must conduct a number of simultaneous operations and dexterous manipulations in order to properly dispense the fluid from the container to the fuel tank: hold the dispensing container at a proper angle and height to induce flow, hold the fuel tank in a proper position to receive the fuel being distributed, and observe both the dispensing container and the fuel tank to “sense” when the desired amount of fuel is distributed from the container to the fuel tank. This may cause either or both the container or the device to be mishandled, resulting in spillage of fuel or potential injury to the user. Third, the fuel tank is often attached to some piece of equipment, such as, for example, a lawnmower, a grass trimmer, or a grass edger, that is not free-standing, requiring the person pouring the fluid to hold the device in a proper receiving position. Fourth, the device may be designed in a way where refueling shortly after use is not easy: the hot engine may be exposed near the inlet of the fuel tank or the device may be heavy to hold with one hand. As a result of all of the foregoing, the fuel tank may be over-filled or under-filled since it is difficult to precisely regulate the amount of fluid dispensed from the container. Once fluid flow is set in motion, excess fluid readily collects and moves through the pouring spout. Consequently, a rapid movement of the dispensing container to stop the fluid flow by repositioning to a non-pouring position often fails to correct an overfill.

Fluid overflows are hazardous. The materials used as fuels are flammable but also may be toxic to humans if spilled onto the skin—absorption through the skin or later ingestion (if the material is not properly cleaned off) may occur. Fluid spillage to the ground is wasteful and may damage the environment. Fuel spillage onto hot equipment may result in damaging residue on the equipment or the fuel catching fire causing thermal and combustion damage.

Transporting full fuel containers is not easy. Often containers are not completely full (i.e., they retain a vapor space inside the container), resulting in the contained liquid shifting and moving in a Newtonian manner to the changes in motion of the container in which it is held. Given enough force and momentum imparted to the contained liquid, a sudden shift in momentum to the container may impart a force on the container that results in the container overcoming frictional forces holding it in place. By overcoming frictional forces, the container may begin to slide and move around. If the container has significant mass and momentum behind it, it may result in collisions that damage the container or objects the container strikes, injure people, or break open the container and spilling its contents, resulting in compounding risk and damage.

### SUMMARY OF THE PRESENTED EMBODIMENTS

A fuel dispensing system including a internally hollow container for use in containing and dispensing a fuel, where the container comprises a lower fuel dispensing orifice, and a dispensing nozzle coupled to the internally hollow container at the lower fuel dispensing orifice capable of being positioned in at least an open or closed state, where the dispensing nozzle is coupled with the container at the lower fuel dispensing orifice in such a manner as to provide a fluid pathway between the internal portion of the container and the distal end of the dispensing nozzle when the dispensing nozzle is positioned in an open state.

A vehicle mounted fuel dispenser system including a mounting bracket fixedly secured to a vehicle, an a internally hollow container secured within the confines of the mounting bracket, wherein the container comprises a lower fuel dispensing orifice, and a dispensing nozzle coupled to the container at the lower fuel dispensing orifice capable of being positioned in at least an open or closed state, where the dispensing nozzle is coupled with the container at the lower fuel dispensing orifice in such a manner as to provide a fluid pathway between the internal portion of the container and the distal end of the dispensing nozzle when the dispensing nozzle is in an open state, and where the mounting bracket provides means for securing the internally hollow container during transport and use.

The summary of the invention is not intended to represent each embodiment or every aspect of the invention.

### BRIEF DESCRIPTION OF THE DRAWINGS

A more complete understanding of the method and apparatus of the invention may be obtained by reference to the following Detailed Description when taken in conjunction with the accompanying Drawings wherein:

FIG. 1 is a perspective view of an embodiment of a fuel dispenser system mounted onto a truck bed;

FIG. 1A is a perspective view of another embodiment of a fuel dispenser mounted onto a truck bed;

FIGS. 2A, 2B, 2C, and 2D are perspective, back, front, and side views, respectively, of an embodiment of a container;

FIGS. 3A-E are views of several components of embodiments of the fuel dispenser;

FIG. 4 is a partially connected side view depicting embodiments of a lower fuel dispensing orifice, a dispensing nozzle, and a hose of the fuel dispenser; and

FIG. 5 is a view of a mounting bracket used as part of the fuel dispenser system.

### DETAILED DESCRIPTION OF ILLUSTRATIVE EMBODIMENTS

Various embodiment(s) of the invention will now be described more fully with reference to the accompanying Drawings. The invention may, however, be embodied in many different forms and should not be construed as limited to the embodiment(s) set forth herein. The invention should only be considered limited by the claims as they now exist and the equivalents thereof.

A need exists for a fluid dispensing container which permits fluids, especially fuels, to be dispensed from the container at a controlled rate and more effectively than prior art dispensers. A need exists for a container which may be appropriately positioned so as to permit a more effective transfer of the fluid from the dispensing container to the fuel tank while also allowing for a more responsive cessation of fluid flow. There is a further need for a container for dispensing fluid in which means used to convey fuel to the fuel tank may be more effectively controlled without active manual handling so as to free the user's hands to control the device being fueled and the manner of distributing the fuel. A further need exists to halt fuel flow from the dispensing container quickly and effectively, especially in situations where the device or the container may be mishandled. A further need exists for a fluid dispensing container which dispenses fluid more expeditiously, uniformly and constantly than existing dispensing devices. A further need exists for a restraint system that prevents the dispensing container from coming loose during transport, even when the container is full. A further need exists for a restraint system that is easy to use. A further need exists for a dispensing container that supports in-situ mixing of different fuels so as to permit their uniform conveyance.

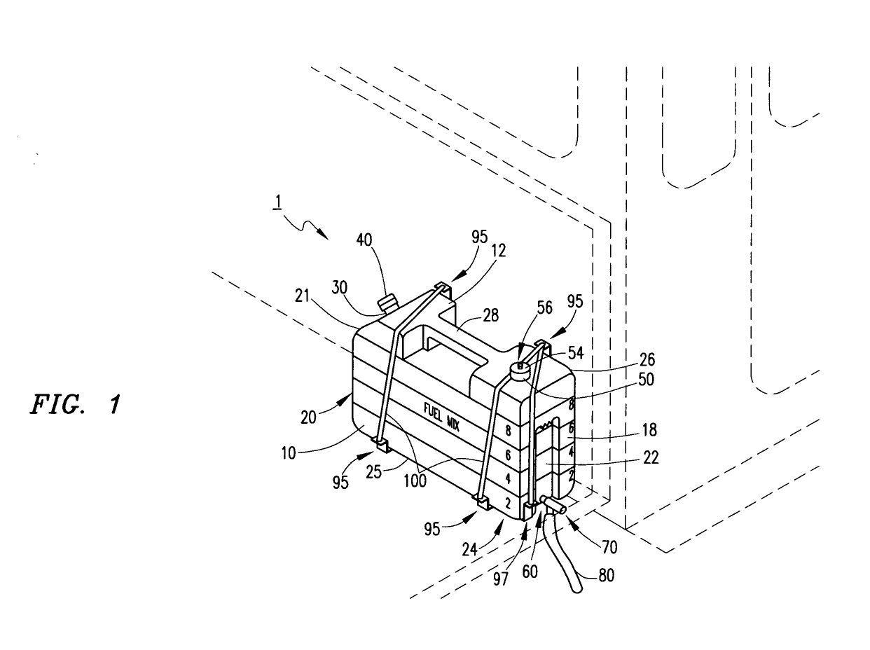

In various embodiments, an embodiment of a fuel dispenser system 1 is seen in FIG. 1 in context on the back of vehicle, such as a truck used in the construction and maintenance arts. In another embodiment, as seen in FIG. 1A, the fuel dispenser system 1 is mounted to a vehicle with a rear tailgate and partially enclosed rear bed. Those skilled in the art will appreciate that even though FIGS. 1 and 1A show the fuel dispenser system 1 mounted onto the back or flat portion of a vehicle, other embodiments within the scope of the invention may include, for example, simply elevating the fuel dispenser system 1 to a vertically fixed position such as a table top, a bench top, a shelf, or other stable position. It may also be appreciated that a secure mounting for the fuel dispenser system 1 may not be required in such situations.

In the embodiment shown in FIG. 1, a fuel container 10 comprised of a top 12, an underside 14, two sides 16, a back 18, a front 20, a front angle portion 21, and a back recess 22 that, in combination, define an internally hollow container for containing and storing fuel F. Although the container 10 may be of a wide variety of shapes and configurations, planar surfaces, as opposed to circular configurations, provide a dispensing container 10 which may be more effectively positioned in a manner for easier and stable use by a user to supply a fuel tank, such as on the back of a truck as shown in FIG. 1. In some embodiments, the fuel container 10 may possess rounded edges 25 and corners 26 to provide a smoother surface that is less likely to damage and be damaged by other objects. In some other embodiments, the fuel container 10 may possess a handle 28 to assist users in manually controlling the fuel dispenser system 1. As presented in the embodiment shown in FIG. 1, the handle 28 may be pre-formed as part of the fuel container 10 as part of the top 12. The handle may be formed in some embodiments to provide internal fluid communications with other parts of the container 10. The handle 28 may be mounted between the front angled portion 21 and the back 18 to provide a convenient and balanced way for a user to carry the container 10. In some other embodiments, the fuel container 10 may be further comprised of level markings 24 on the sides 16, back 18, front 20, or back recess 22 to reflect the volume or percent amount of fluid contained. Examples of level markings may include, as shown in FIG. 1, level lines and numbers indicating the volumetric amount of fluid in the fuel container 10. In some embodiments, the fuel container 10 may also comprise a transparent or semi-transparent section to allow the user to visually realize the amount of fuel held within the container at any given time.

In some embodiments, the container 10 (and all of the aforementioned attributes mentioned) may be fabricated from a plastic which is resistant to the corrosive effects of fuels, such as are known in the art. The container 10 may also be created as a unitary in structure so as to minimize container cost and weight, thereby improving handability and strength through such processes as injection molding and polymer welding. Plastic resins that may form the basis for such a container include polyalkanes, such as high-density polyethylene or polypropylene, or (poly) vinyl chloride, or (poly) fluoro ethylene, and the like. The material and method of construction may, in some embodiments, endow container 10 with semi-transparency, permitting fuel F to be seen, or at least the level of the fuel to be observed, external to container 10. The material of construction may also be colored using colorants known to ones skilled in the art to give an aesthetically pleasing quality. For example, the container 10 may be colored red in a manner to reflect that the container is designed under U.S. Federal Regulations to comply with containing straight gasoline. In another example, the container 10 may be colored another color, such as green, to reflect that the container does not contain straight gasoline or another regulated fuel substance to the professional user.

In some embodiments, the designed size of the fuel dispenser system 1 may reflect the desire to contain and distribute up to four U.S. gallons of fuel. In such embodiments, the level markings 24 may reflect increasing increments of one U.S. gallon. In some other embodiments, the designed of the fuel dispenser system 1 may reflect the desire to contain up to eight U.S. gallons of fuel. In such embodiments, the level markings 24 may reflect increasing increments of two U.S. gallons. In some embodiments, the container 10 may be emblazoned with other markings to present to the observer messages regarding the contents of the fuel dispenser system 1, such as a warning regarding the material contained or a label such as “FUEL MIX”.

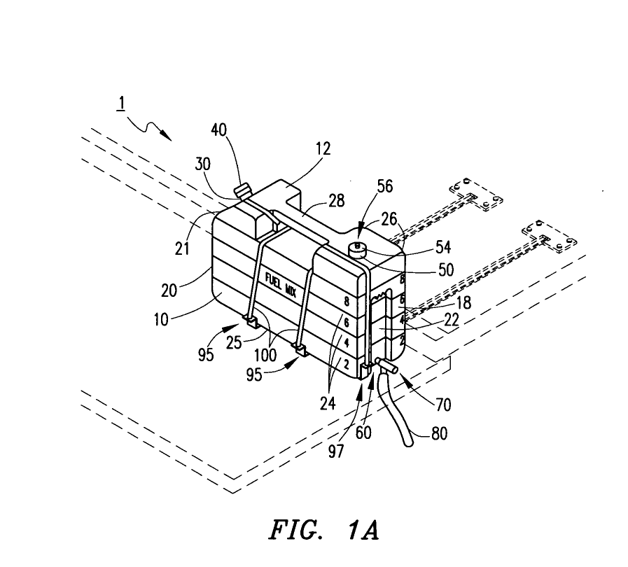

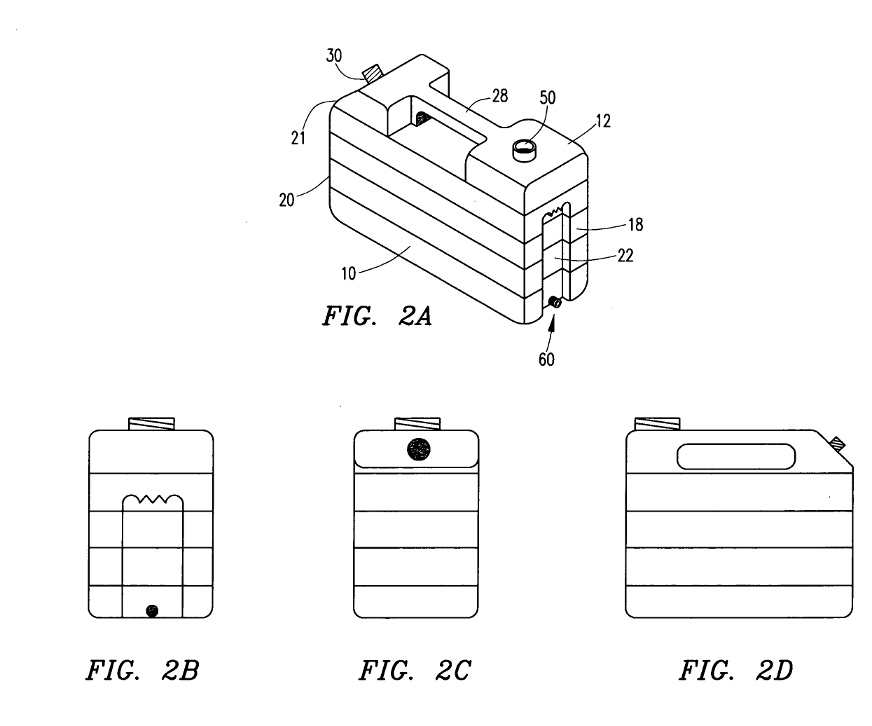

In some embodiments, the container 10 may comprise one or more orifices. These orifices may be used for fluid communication between the inside and the outside of the container 10. In some embodiments, the container 10 may further comprise a standard dispensing orifice 30. In some embodiments, the standard dispensing orifice 30 may be located as part of the front angle portion 21 as can be seen in FIGS. 2A, 2C, and 2D. Standard dispensing orifice 30 may be, in some embodiments, approximately 1″ in diameter. A user provided with this embodiment would be able to pour the contents out of the container 10 by tilting container 10 forward. Standard dispensing orifice 30 may possess in some embodiments threads 32, permitting threaded connectivity to assist the user attaching devices such as a standard-sized flow nozzle to assist in dispensing fuel F using this orifice. FIG. 3A shows an embodiment of a possible nozzle attachment, a reversible flexible dispensing nozzle 40, comprising a reversible cap assembly 41 with two opposing sets of internal recessed threads 42 gauged to threadedly engage with the threads 32 of the standard dispensing orifice 30, a set of recessed sealing rings (not pictured) positioned at the base of each set of internal recessed thread 42, and a flexible nozzle 44 protruding from the reversible cap assembly 41. In an embodiment, a standard orientation for the reversible flexible dispensing nozzle 40 may be used wherein the reversible flexible dispensing nozzle 40 may be threadedly engaged to the standard dispensing orifice 30 in such a manner that the flexible nozzle 44 protrudes externally from the container and acts as a flow conduit for fuel F if a user chooses to dispense fuel F from the standard dispensing orifice 30. In a different embodiment, a reverse orientation may be used wherein the reversible flexible dispensing nozzle 40 may be threadedly engaged to the standard dispensing orifice 30 in such a manner that the flexible nozzle 44 protrudes internally, as may be seen in FIG. 1. In such an arrangement, a cap (not pictured) may be threaded into the exposed recessed threads 42 of the reversible flexible dispensing nozzle 40 to provide a seal between the internal and external environments.

In some embodiments, the container 10 may further comprise a mass flow orifice 50. A mass flow orifice 50 in some embodiments may facilitate certain operations easier than the standard dispensing orifice 30, such as filling the container 10 with fluids from a mechanical nozzle (e.g., gasoline or diesel from a commercial pump nozzle), creating mixtures of fluids in situ container 10 (e.g., pouring gasoline into container 10 and then following with an amount of oil to create a gas/oil fuel mixture), and venting container 10 during draining operations. In some embodiments, the mass flow orifice 50 may be larger than the standard dispensing orifice 30. In some embodiments, the mass flow orifice 50 is located on the top 12 to assist the controlled venting of gases as part of a draining operation. Controlling fluid flow by regulating the amount of air vented into container 10 assists in providing flow control over fuel F leaving the container 10 as, typically, air replaces the volume of fuel F leaving the container 10. Insufficient air venting usually crates uneven and uncontrollable fluid discharge. A small inlet air rate of air will afford a uniform and constant slow discharge of fuel F from container 10. Conversely, a fully opened venting means would provide rapid discharge of fuel F. In some embodiments, a mass flow cap 54 with a vent 56, as shown in FIGS. 1, 1A, and 3B, may provide regulation of the amount of air admitted to container 10 while discharging fuel F from the container 10. In some embodiments, the mass flow cap 54 may be attached to the mass flow orifice 50 through several means known in the art, including but not limited to a lip on the mass flow orifice 50 and reciprocal edge on the mass flow cap 54 or by threaded connections 52 as shown in FIGS. 2A and 2D. A vent 56 may be present in some embodiments of the mass flow cap 54. The vent 56 may, in some embodiments, take the form of a hole in the top of the mass flow cap 54 such as shown in FIG. 3B. In other embodiments, the vent 56 may take the form of a pull top, as can be viewed in FIG. 1, where the gaseous communication can be more easily regulated by positioning the cap to reflect an air inlet flow rate desired.

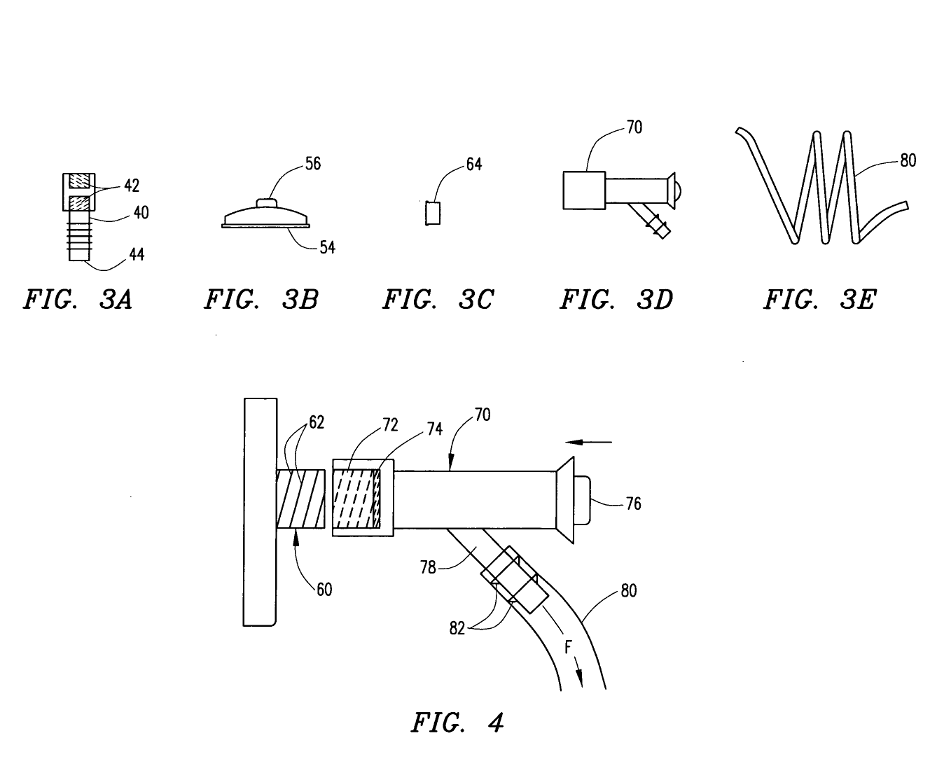

In some embodiments, the container 10 may further comprise a lower fuel dispensing orifice 60. In some embodiments, the lower fuel dispensing orifice 60 may provide a means for draining fuel F by using the force of gravity from container 10 when fuel dispenser system 1 is placed in an elevated position. In some embodiments, the lower fuel dispensing orifice 60 may be located on back recess 22. In some embodiments, the length of lower fuel dispensing orifice 60 is at most equal to than of the linear distance between the planes of the back recess 22 and the back 18. In other embodiments, the length of the lower fuel dispensing orifice 60 is less than the aforementioned linear distance. In some embodiments, the diameter of the lower fuel dispensing orifice 60 is less than the diameter of the standard dispensing orifice 30. As seen in FIG. 4, the lower fuel dispensing orifice 60, in some embodiments, has threads 62 for providing threaded connectivity. In some embodiments, a dispensing nozzle 70 as may be seen in FIGS. 3D and 4 may be attached to the distal end of the lower fuel dispensing orifice 60. The dispensing nozzle 70 is capable of being in either an open state, wherein fluid is permitted to pass through the nozzle with little encumbrance, or a closed state, wherein fluid is not permitted to pass through the nozzle. The dispensing nozzle 70 may also have a graduated opening, wherein a closed state and a gradually greater open state exists based upon manipulation by the user. An example of such a dispensing nozzle may include a push-button nozzle, wherein the user may depress the button to different degrees and open the valve slightly or fully while in the open state. In an embodiment shown in FIG. 4, a dispensing nozzle 70 may comprise a Y-shaped body with recessed threads 72 and a washer 74 to threadedly connect to the lower fuel dispensing orifice 60 and provide a seal against fluid leakage, a push button 76 that, when depressed, activates a spring-biased internal valve structure (not pictured) that permits fluid flow through the dispensing nozzle 70, a Y-shaped branch 78 that functions as the outlet for fluid flow, and hose restraint ridges 82 on the Y-shaped branch 78 so as to permit gripping attachment of a hose 80 to the dispensing nozzle 70 discharge. In such embodiments, when the push button 76 is no longer manually depressed, the internal valve structure repositions itself to a normal state and the fluid pathway inside the dispensing nozzle 70 is closed. In some embodiments, a hose 80 as shown in FIG. 3E is attached to the Y-shaped branch 78 at the hose restrain ridges 82 so as to provide a flow conduit from the dispensing nozzle 70 to the fuel tank to be filled as shown in FIG. 4. In some embodiments, the hose 80 is attached to the dispensing nozzle 70 using other securement means know in the art, such as by tie-wrap. In some embodiments, the distal end of hose 80 is placed inside the receiving fuel tank so as to provide a path from the container 10 to the fuel tank for fuel F to flow while not manually holding hose 80 during refueling operations. Other valves, nozzle structures, and hoses are known in the art may be used to provide on/off or restricted flow control of the fluid F flowing through the lower fuel dispensing orifice 60. When the lower fuel dispensing orifice 60 is not in use, in some embodiments an internally threaded cap 64, as may be seen in FIG. 3C, may be used to seal the orifice from external communication.

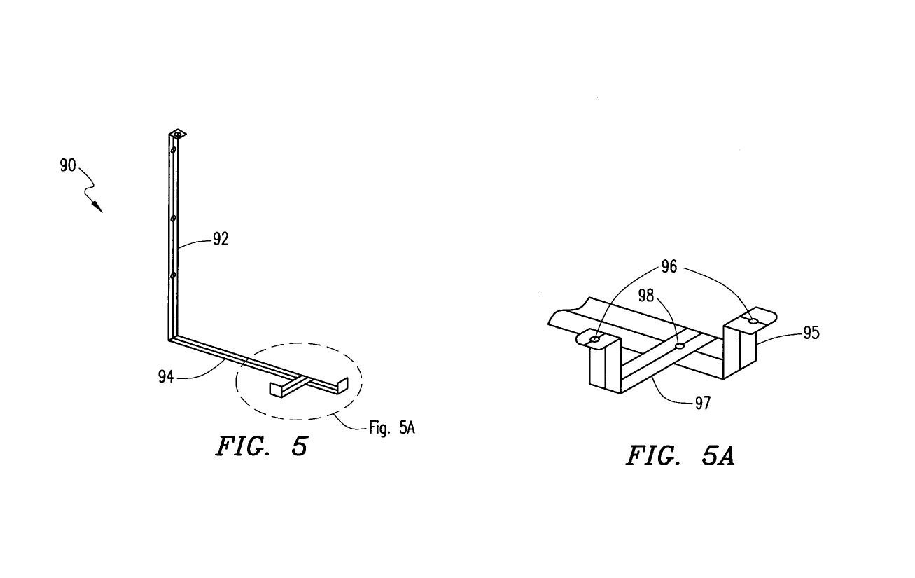

In some embodiments, a mounting bracket 90 may be used as part of the fuel dispenser system 1 to help secure and restrain container 10 during transportation and dispensing of fuel F from the rear of a vehicle. As can be seen in the embodiment shown in FIG. 5, a mounting bracket 90 may be comprised of several parts, including a back portion 92, which may be used to secure the bracket to a flat surface such as (but not limited to) the back wall of a truck bed, and an underside portion 94, which extends under the container 10. The mounting bracket 90 may be secured to a flat body in a number of ways known to one skilled in the art, including welding and riveting. In some embodiments, the ends of the mounting bracket 90 may be altered to create bracket extensions 95. The bracket extensions 95 may be used to help physically restrain container 10 within an area defined by a or several mounting brackets 90. In some embodiments, as can be seen in FIG. 5, a swivel bracket 97 may be incorporated into the mounting bracket 90. In such embodiments, the swivel bracket 97 may take the general shape of the bracket extensions 95 to help secure a container 10 within an area defined by the mounting bracket 90. Besides providing assistance with containment, the swivel brackets 97 may be attached to the mounting bracket 90 by use of a swivel connector 98, permitting the swivel bracket 97 to rotate and move when not in a securement position. In such embodiments, the swivel bracket 97 may be moved by a user in such a manner so that the swivel bracket 97 does not obstruct the user's ability to slide the container 10 from an elevated position. In some embodiments, the bracket extensions 95 and swivel brackets 97 may possess eyelets 96. Eyelets 96 may be used to thread restraining straps 100, such as but not limited to rope or “bungie” cords, to assist in securing and confining container 10 during transport and use. FIGS. 1 and 1A show different embodiments of mounting brackets 90. FIG. 1 shows an embodiment wherein mounting brackets similar to the embodiments shown in FIG. 5 are used. FIG. 1A shows embodiments wherein the mounting brackets 90 are secured to an underside extension.

The container 10 of the fuel dispenser system 1 may be filled with a fuel F either in an elevated position or on the ground by removing the mass flow cap 54 and dispensing fuel F into container 10 through the mass flow nozzle 50 to a desired amount, afterwards replacing the mass flow cap 54 onto the mass flow nozzle 50 to secure fuel F in the container 10 from contamination and spillage. Either before or after filling container 10, the fuel dispenser system 1 may be repositioned front 20 downwards to support attachment of a dispensing nozzle 70 onto the lower fuel dispensing orifice 60. In some embodiments, attachment of the dispensing nozzle 70 occurs after transporting the fuel dispenser system 1 to the remote work site so as to prevent damage to or accidental discharge from the dispensing nozzle 70.

To use the various embodiments of the fuel dispenser system 1 as a remote fuel dispensing system, the fuel dispenser system 1 may be mounted in an elevated position, such as on the back of a truck bed as may be seen in FIG. 1, for transport. While in this elevated position, the container 10 may be secured in place by using previously secured mounting brackets 90 wherein restraining straps 100 are attached between various eyelets 96 on both bracket extensions 95 and swivel brackets 97. The swivel brackets 97 may be positions to further restrain container 10 from movement.

After transport to the remote work site, the fuel dispenser system 1 may assist a user in filling fuel tanks using a variety of means. A user may pour fuel in a traditional manner from the container 10 (after removing the previously attached securement measures) by using the standard dispensing orifice 30 with the reversible flexible dispensing nozzle 40 configured and secured in a standard orientation and then by tilting the fuel dispenser system 1 forward until fuel F flows from the container 10 to the fuel tank. A user may also siphon fuel F from the container 10 by use of a siphon pump (not picture) inserted into container 10 through the mass flow nozzle 50. A user may also draw fuel F from the bottom of the container 10 through the lower fuel dispensing orifice 60 by ensuring the container 10 is elevated and allowing gravity to pull fuel F through the lower fuel dispensing orifice 60, regulating the flow by use of a dispensing nozzle 70. In drawing fuel from the lower fuel dispensing orifice 60 wherein the container 10 is in a secured, elevated position, the user may use one hand to activate the dispensing nozzle 70 and another to hold and position the device with the fuel tank to be filled. The user may also enhance the accuracy of controlling the flow into the fuel tank by using a hose 80 securely attached to the dispensing nozzle 70, wherein the distal end of the hose 80 is placed inside the fuel tank. This method provides the user with not only fuel F flow control from container 10 but also control over the device being fueled, thereby reducing the occurrence of accidents and spills which might damage the user, the equipment being filled, and the environment. In using methods wherein the mass flow cap 54 seals the mass flow orifice 50, opening or controlling the position of the vent 54 may assist in regulating the overall flow of fuel F from container 10.

Although various embodiments of the method and apparatus of the invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

What is claimed is:

1. A fuel dispenser system, comprising:
an internally hollow container for use in containing and dispensing a fuel, wherein the container comprises a lower fuel dispensing orifice; and
a dispensing nozzle coupled to the internally hollow container at the lower fuel dispensing orifice capable of being positioned in an open or closed state;
wherein the dispensing nozzle is coupled with the container at the lower fuel dispensing orifice in such a manner as to provide a fluid pathway between the internal portion of the container and the distal end of the dispensing nozzle when the dispensing nozzle is positioned in at least an open state.

2. A system according to claim 1, further comprising a mass flow orifice.

3. A system according to claim 2, further comprising a mass flow cap.

4. A system according to claim 3, wherein the mass flow cap is comprised of a vent.

5. A system according to claim 1, further comprising a standard flow orifice.

6. A system according to claim 5, further comprising a standard-sized flow nozzle.

7. A system according to claim 6, wherein the standard-sized flow nozzle is comprised of a reversible flexible dispensing nozzle.

8. A system according to claim 1, wherein the material of construction of the container is selected from the group consisting of polyalkanes, (poly) vinyl chloride, (poly) fluoro ethylene, and mixtures thereof.

9. A system according to claim 1, wherein a portion of the container is semi-transparent.

10. A system according to claim 1, wherein the container is semi-transparent

11. A system according to claim 1, wherein the container further comprises level markers.

12. A system according to claim 1, wherein the lower fuel dispensing orifice resides within a recess of the container.

13. A system according to claim 1, wherein the container further comprises a handle.

14. A system according to claim 13, wherein the handle is in internal fluid communications with the container.

15. A system according to claim 1, wherein the means for securing the internally hollow container during transport and use is by use of restraining straps.

16. A system according to claim 1, further comprising a mounting bracket.

17. A system according to claim 16, wherein the mounting bracket is secured to a vehicle.

18. A system according to claim 16, wherein the mounting bracket further comprises a swivel bracket.

19. A vehicle mounted fuel dispenser system, comprising:
a mounting bracket fixedly secured to a vehicle;
an internally hollow container secured within the confines of the mounting bracket, wherein the container comprises a lower fuel dispensing orifice; and
a dispensing nozzle coupled to the container at the lower fuel dispensing orifice capable of being positioned in an open or closed state
wherein the dispensing nozzle is coupled with the container at the lower fuel dispensing orifice in such a manner as to provide a fluid pathway between the internal portion of the container and the distal end of the dispensing nozzle when the dispensing nozzle is in at least an open state; and
wherein the mounting bracket provides means for securing the internally hollow container during transport and use.
